(19) United States
(12) Patent Application Publication
(10) Pub. No.: US 2003/0119409 A1
(43) Pub. Date: Jun. 26, 2003

(54) Improved dry crimp strength in non-heat seal infusion package material

(76) Inventors: Helen Viazmensky, Avon, CT (US); Peter Scott, Enfield, CT (US)

Correspondence Address: ALIX YALE & RISTAS LLP, 750 MAIN STREET, SUITE 1400, HARTFORD, CT, 06103, US

(21) Appl. No.: 09/489,539

(22) Filed: Jan. 21, 2000

(51) Int. Cl. B32B 5/06; B32B 5/26

(52) U.S. Cl. 442/389; 428/316.6; 426/77; 426/84; 210/490

(57) ABSTRACT

A fibrous, non-woven, non-heat sealable, porous web material comprising natural fibers and 0.5 to 25 percent synthetic material is provided. The web material has properties well suited for use in infusion packages. The web material exhibits improved stiffness and memory characteristics which lead to significantly improved strength of mechanically formed and crimped seams.

### FIELD OF THE INVENTION

The present invention relates generally to fibrous web material intended for use in infusion packages for brewed beverages, such as tea, coffee and the like. It is more particularly concerned with a new and improved fibrous non-heat seal nonwoven web material having an improved dry crimped seam strength.

### BACKGROUND OF THE INVENTION

Infusion packages for brewing beverages, such as tea bags and coffee bags, are generally produced by enclosing beverage precursor materials within a porous web material. The infusion package is either placed in a cup or pot containing boiling water, or alternatively, the infusion package is placed in an empty cup or pot and subsequently boiling water is added. In either event, the boiling water passes through the web material into the bag to extract the beverage precursor materials and the extract passes outwardly of the bag to form the brew.

Infusion packages are generally made of fibrous nonwoven web materials that are free from perforations or punctures yet possess a high degree of porosity. Particularly favored for infusion packages are those wet laid fibrous materials made on inclined wire paper making machines using long natural fibers. These web materials are generally soft, tissue-thin fibrous materials characterized by their light weight and superior infusion characteristics.

While it is desirable for the infusion package to allow extraction of the beverage precursor materials, physical release of the solid materials from the sealed infusion package into the cup is undesirable. To prevent movement of solid beverage precursor materials from the sealed infusion package into the brewing container the porosity and “sifting” characteristics of the nonwoven web material are carefully controlled. More importantly, the seam maintaining the beverage precursor materials within the infusion package must maintain integrity to prevent opening of the infusion package and the subsequent undesirable discharge of beverage precursor materials into the brew.

Infusion package seams may be of either the “heat seal” or “non-heat seal” variety. Heat seal infusion packages are typically produced from a nonwoven web material comprising two layers or phases. One of the two phases typically includes more than twenty-five percent by dry weight of fusible polymeric fibers. The web material is folded so that the surfaces containing the fusible fibers are in contact. Application of heat and pressure melts, flows and fuses the touching fusible fibers and creates a heat seal seam joining the layers of web material. The surface of the second layer is free of fusible fibers and functions to prevent sticking of the melted polymeric fibers to the heated dies used to create the heat seal seam.

Contrastingly, in non-heat seal infusion packages, the edges of the web material are brought together, folded a number of times, and this multiple fold is crimped to provide a mechanical crimped seam which seals the infusion package. Typically, the nonwoven web material used for non-heat seal infusion packages includes a single layer comprised of vegetable fibers and does not incorporate fusible polymeric fibers.

There is, in some instances, a problem with non-heat seal infusion packages in that the seams may become opened due to a weakening of the web material at the crimped fold or to opening of the fold in the boiling water environment due to pressure may be exerted on the fold by the expansion of gases trapped within the infusion package. As previously discussed, even partial opening of the seams leads to an undesirable physical discharge of the beverage precursor materials such as tea leaves into the brewing container.

Naturally, the fibers used for the production of infusion packages must be approved by the Food and Drug Administration (FDA) for use as packaging for food products.

It is known to use synthetic fibers as a binder to impart strength to non-heat seal web materials. The known synthetic binders require application of heat and pressure sufficient to melt and flow substantially all of the binder fibers, so that they can flow and fuse with the other web materials and, upon cooling, bind the web together.

Such processing of synthetic binder materials tends to lessen the porosity of the resulting web material. These synthetic binder web materials are used in applications such as battery cell separators, but have not traditionally been approved for use in food packaging. To the inventors' knowledge, a fibrous, non-heat seal nonwoven web material incorporating synthetic binder fibers has not been used to create an infusion package.

### SUMMARY OF THE INVENTION

It is an object of the present invention to provide a new and improved non-heat seal, nonwoven fibrous web material with improved mechanical fold or crimp strength.

It is another object of the invention to provide nonwoven fibrous web material which can be processed on existing infusion package sealing equipment to provide a higher strength mechanical seam than conventional web materials.

It is a further object of the invention to provide a nonwoven fibrous web material which retains the desirable porosity and infusion characteristics of conventional non-heat seal infuser web materials while providing greater mechanical fold strength.

Other features and advantages of the present invention will be in part obvious and in part pointed out in more detail hereinafter.

In accordance with the present invention, it has been found that mechanical seam integrity can be enhanced by incorporating controlled amounts of solid synthetic materials into conventional non-heat seal type web materials. Solid synthetic materials as used in this application refers to both synthetic fibers and synthetic pulp. The resulting non-heat seal nonwoven web materials exhibit improved stiffness and memory characteristics which lead to significantly increased crimp strength when compared to conventional non-heat seal web materials. The increased crimp strength translates to an increased strength for the finished infusion package crimped seal.

In one disclosed embodiment, the fibrous non-heat seal web material comprises a single-phase porous sheet material containing throughout its extent 0.5 to 25 percent by weight of synthetic materials and preferably 3 to 10 percent. Typically, 6 percent by weight of the synthetic material is used. In another embodiment, the synthetic materials are incorporated into at least one phase of a fibrous multi-phase non-heat seal web material. The synthetic materials incorporated will account for 0.5 to 25 percent by weight of the resulting web material. Preferably, the multi-phase fibrous web material will incorporate 1 to 10 percent, and typically 6 percent, synthetic materials. The inventive materials do not require substantial activation of the synthetic material. Further, even at the higher amounts of synthetic materials, the inventive non woven web materials are not capable of forming an effective heat seal seam.

A better understanding of the invention will be obtained from the following detailed disclosure of the article and the desired features, properties, characteristics, and the relation of the elements as well as the process steps, one with respect to each of the others, as set forth and exemplified in the description and illustrative embodiments.

### DESCRIPTION OF A PREFERRED EMBODIMENT

Broadly, the present invention comprises fibrous, non-woven, porous web materials, including natural fibers and synthetic materials. The resulting web materials are especially suited for the production of infusion packages. The inventive web materials are of the non-heat seal variety, i.e. they can not form an effective seam upon application of heat and pressure and, thus, require mechanical fastening, i.e., folding and crimping for the formation of the infusion package. The inventive web materials exhibit surprisingly increased mechanical seam strength compared to conventional non-heat seal web materials which do not utilize synthetic fibers or pulps.

The predominant fibers utilized in the inventive web materials may be any of the well known natural paper making fibers or mixtures thereof. They must be approved by the Food and Drug Administration (FDA) for use in food and beverage applications and preferably include long natural fibers such as jute, abaca, sisal, hemp, kenaf and mixtures of the above. These long natural fibers are substantially uniform in length, varying from 4 to 7 millimeters (mm) and are substantially free of minute fibers. The long fibers are relatively cylindrical, are slightly tapered and have little tendency to curl or twist when dispersed in solution. Shorter wood fibers, such as bleached or unbleached kraft, may also be used, either alone or in combination with other fiber types.

A variety of webs may be made from these fibers and utilized in accordance with the present invention. It will be appreciated that such materials, while being extremely porous and highly wettable, are generally free from perforations and will not permit the fine particles of the beverage precursor material to filter or sift through the infusion packages made therefrom.

According to one aspect of the present invention, a slurry of the previously described natural fibers is prepared. Details of the previously described natural fibers and their preparation into a slurry are well known to those of ordinary skill in the art. To this slurry an amount of synthetic material is dispersed.

The synthetic materials may be polyesters, thermoplastic materials such as polyolefins or mixtures thereof. The synthetic materials may include those with fiber morphologies of synthetic shortcut fibers, synthetic pulps or mixtures thereof. The synthetic fibers exhibit conventional smooth cylindrical or rod-like morphology with low specific surface area. Synthetic fibers have typical lengths of 1-25 mm, typical denier of 0.5-15 and typically low surface areas. Synthetic fibers are usually formed by a process such as melt spinning.

The synthetic pulps are synthetic thermoplastic materials, such as polyolefins, having a structure more closely resembling wood pulp than synthetic fibers. That is, they contain a micro-fibrillar structure comprised of micro-fibrils exhibiting a high surface area as contrasted with the smooth, rod-like morphology of conventional synthetic fibers.

The synthetic thermoplastic pulp-like material can be dispersed to achieve excellent random distribution throughout the aqueous dispersing media in a paper-making operation and, consequently, can achieve excellent random distribution within the resultant sheet product. The pulps found particularly advantageous in the manufacture of infusion sheet materials are those made of the high density polyolefins of high molecular weight and low melt index.

The fibrils can be formed under high shear conditions in an apparatus such as a disc refiner or can be formed directly from their monomeric materials. Patents of interest with respect to the formation of fibrils are the following: U.S. Pat. Nos. 3,997,648, 4,007,247 and 4,010,229. As a result of these processes, the resultant dispersions are comprised of particles having a typical size and shape comparable to the size and shape of natural cellulosic fibers and are commonly referred to as “synthetic pulp”. The particles exhibit an irregular surface configuration, have a surface area in excess of one square meter per gram, and may have surface areas of even 100 square meters per gram. The particles exhibit a morphology or structure that comprises fibrils which in turn are made up of micro-fibrils, all mechanically inter-entangled in random bundles generally having a width in the range of 1 to 20 microns (μ). In general, the pulp-like fibers of polyolefins such as polyethylene, polypropylene, and mixtures thereof have a fiber length well suited to the paper-making technique, e.g., in the range of 0.4 to 2.5 mm with an overall average length of about 1 to 1.5 mm.

The resulting “furnish”, comprising the slurry of natural fibers to which the synthetic fibrous material (either fibers, pulp or mixtures thereof) has been added and dispersed, is wet laid on an inclined wire paper making machine in a fashion also well known to those of ordinary skill in the art. The resulting web material will have a synthetic material content of 0.5 to 25 percent, more preferably 1 to 10 percent, and typically 6 percent, by weight. While the inventive web materials have a surprisingly increased crimp strength at low synthetic fiber concentrations, this increased strength is diluted below 1 percent. It should be understood that this amount of synthetic fibrous material used in a non-woven web material is not sufficient to enable the web material to create an adequate heat seal seam. Thus, the inventive non-woven material cannot be used as a substitute for heat-seal type web materials.

As previously mentioned, the invention is also applicable to multi-phase non-woven web materials. In this connection, numerous different techniques have been employed to make multi-phase fibrous webs. Typical of those techniques found useful in the production of multi-phase web materials is the dual head box technique described in U.S. Pat. No. 2,414,833. In accordance with that process, a first furnish flows through a primary head box and continuously deposits as a bottom layer or base phase on an inclined, web forming wire screen. A second furnish or slurry for the top layer or second phase is introduced into the primary head box at a location immediately after or at the point of deposition of the base phase on the inclined wire screen. This may be carried out by means of an inclined trough or by a secondary head box in such a manner that the top phase fibers commingle slightly with the base fibers flowing through the primary head box. In this way, the base fibers have a chance to provide a base mat or phase, prior to the deposition of the second or top phase. As can be appreciated, the top phase is secured to the base phase by an interface formed by the intermingling of the particles within the aqueous suspension. Typically, webs produced in this manner have the first phase covering the entire area of the web surface in contact with the inclined wire screen while the opposing side of the web has a mixture of fibers with the top phase fibers greatly predominating. In this way there is not a clear line of demarcation between the two phases of the multi-phase sheet materials; yet there is a predominance of top phase fibrous material on the top surface or top phase of the multi-phase sheet. The center or interface boundary, of course, is composed of a mixture of the two different types of fibers. It should be appreciated that the invention also covers webs comprising three or more layers.

Although the technique or process described in the aforementioned U.S. Pat. No. 2,414,883 is preferably followed, the materials used in preparing the furnishes for each phase of the web material will be different. The predominant fibers utilized for the top and bottom phases comprise the previously mentioned natural fibers. It should be understood that the top phase will generally account for 25 to 35 percent of the total basis weight of the resulting web material. To one or both of the top or bottom phase slurries, the previously discussed synthetic material is added. Preferably, the above synthetic material is added to the top phase. The resulting fibrous web material (both phases) will have a synthetic material content of 0.5 to 25 percent, more preferably 1 to 10 percent, and typically 6 percent.

The inventive wet laid web materials in either single or multi phase form are subjected to a drying step to reduce water present in the web. The drying step may comprise vacuum drying, passage around heated drying cylinders or through heated pass through dryers or combinations of the above.

It should be noted that heat sealable type web materials typically undergo an additional heated fusing step subsequent to the drying step to fully “activate” the synthetic fibers. As used herein, activation refers to the imposition of energy to a substance so that the substance will undergo subsequent chemical or physical change more rapidly or completely. Before activation, synthetic materials retain their pre-activation polymer crystallinity and physical morphology. As synthetic materials are subjected to heat and become activated they undergo changes in crystallinity accompanied by reticulation (physical contraction and wrinkling). Continued application of heat will bring the synthetic materials toward their melting point, accompanied by further changes in crystallinity and physical changes such as softening. As the synthetic materials reach their melting point, there is limited fusion of the synthetic materials at the point of contact with touching fibers, either cellulosic or synthetic. Continued application of heat to the stage of overactivation or overfusing will cause the synthetic materials to break up into discrete portions. Thus, activation spans a continuum between no activation and overfusing. Substantial activation of heat seal type non-woven web materials is required for subsequent creation of an adequate heat seal bond in that material.

The inventive web materials receive only the drying step and do not require the subsequent heated activation step. Thus the inventive web materials are preferably only lightly activated. Less preferably, the inventive web materials may be more highly activated, or even overfused. While substantial activation of the inventive materials is not preferred, they will continue to show increased dry crimped seam strength when more highly activated or even when overfused. It should be noted that the inventive non-woven web materials even when substantially activated or overfused will not form an adequate heat seal bond and thus are not replacements for heat seal type non-woven web materials.

It is believed one predominant mechanism of non-woven web material strength is hydrogen bonding of the cellulosic fibers. Replacement of a quantity of cellulosic fibers with an equivalent quantity of synthetic materials lessens the hydrogen bonding within the web material, resulting in decreased tensile strength. Activation of synthetic materials close to, and beyond, their melting point creates a weak bond between the synthetic material and touching fibers at their contact points. However, this bond is of lower strength than the hydrogen bonding of replaced cellulosic materials and the resulting web material will again exhibit lesser or equal strengths when compared to fully cellulosic web materials.

The inventive web materials are also distinguishable from non-woven web materials using synthetic materials as binders. During processing, synthetic binders undergo substantial heating and flow leading to increased bonding within the web material. The substantial flow of synthetic materials leads to the typically increased tensile strengths (greater than 20%) found with such materials and binder systems. In the present materials the synthetic materials exhibit little flow and lesser or equal strength as compared to a fully cellulosic web material.

The inventive web materials may incorporate additional conventional materials and processing. As an example, the materials and processes of U.S. Pat. No. 5,431,997 to Scott et al, which is hereby incorporated by reference, may be used with the inventive web materials.

In any embodiment, it is preferred that the inventive web material has a thickness in the range of 30 to 100 μ, more typically in the region of 40 to 60 μ. The web material of the invention preferably has a basis weight of 9 to 19 grams per meter squared (g/m²) and more preferably 11 to 16 g/m². Typically the basis weight will be about 12-13 g/m². The synthetic materials will account for 0.5 to 25 percent and more preferably 1 to 10 percent of the resulting dry web weight. Typically the synthetic materials will be present at 6 percent of the resulting web weight.

One of the measured characteristics which determines the acceptability of a mechanical seam is crimped seam strength, which is a measurement of the amount of force necessary to pull open a crimped mechanical seam. It is desirable that the dry, crimped seam strength be as high as possible to ensure mechanical seam integrity. While not wishing to be held to any theory, it is believed the synthetic materials impart stiffness and “memory” to the inventive web material which leads to the increased crimped seam strength.

In one test method for dry, crimped seam strength, web material having a preformed and crimped seam is excised to obtain a one inch wide test sample. The excision is such that the crimped seam will horizontally traverse the one inch width of the test sample and be perpendicular to the excised sides. The test sample is mounted in a tensile test instrument, with a top or bottom edge of the sample fastened to a fixed anchor and the opposing edge fastened to a crosshead. The crimped seam is parallel to the fastened top and bottom edges. The crosshead is linearly displaceable in a direction perpendicular to the mechanical seam to be tested. The crosshead is arranged to move away from the anchor at a predetermined speed, placing the test sample and crimped seam under an increasing tensile force. The tensile test instrument will read and record the highest tensile force imposed on the sample, which is indicative of the force at which the mechanically folded and crimped seam failed. The obtained crimped seam strength will be dependant not only on the material but also on the machinery used to form and crimp a seam in the material.

For the test equipment used in the following examples, crimped seam strengths of less than 40 grams/inch (g/in) are unacceptable for an infusion package seam and crimp strengths of 40 to 50 g/in are typical.

On different equipment, crimp strengths of 60 to 150 g/in may be seen.

There is no significant difference between the crimp strength obtained for a conventional single phase web material and a conventional multi-phase material of the same composition and basis weight.

The test procedure to quantify the dry, heat seal seam strength measures the maximum force required to separate the heat sealed seam in a manner similar to that of the above mechanical seam test. A strip of test material is folded in half with the fusible fiber containing phases contacting each other. The heat seal seam is formed by pressing the folded heat seal web material together with heated platens. The platens are maintained at 375° F. and a pneumatic cylinder pressure of 72 psi imposes a force on the platens which is maintained for a dwell time of 0.38 seconds. The heat sealed sample is cut to obtain a one inch wide test sample with the heat sealed seam horizontally traversing the sample. The unsealed top and bottom edges are clamped in the jaws of a tensile test instrument. The seam is placed under an increasing tensile force and the maximum force required to effect seam failure is recorded. Minimum acceptable heat seal seam strengths will be at least 150 g/in and more typically the heal seal seam strength is about 300 g/in.

It should be realized that a variety of web materials may be made from the above fibers, however not every non-woven web material is suited for use in infusion packaging. Suitable infuser web materials must also have a minimum combination of porosity, sifting and infusion properties. For ease of understanding and clarity of description, the invention is below described in its application to non-heat sealable porous infusion web materials for use in the manufacture of tea bags and the like.

The “infusion” characteristics of importance relative to heat seal web material relate to the rate at which water can pass into the tea bag and tea liquor can pass out of the tea bag as well as the degree of extraction which is able to take place within a specified time. This is usually reported in terms of “first color” and “percent transmittance”, respectively. When testing for first color, a tea bag made from the material to be tested is carefully placed in quiet distilled water after the water has been brought to a boil. Using a stopwatch, the time is recorded at which the first amber stream appears at the bottom of the sample. A first color time of less than 12 seconds is required with less than 10 seconds being preferred. A first color of about 5-7 seconds is considered indicative of excellent infusion characteristics. Of course, thicker, heavier basis weight materials typically will have higher first color values than lighter basis weight materials.

The percent transmittance test is conducted by measuring the transmittance of the brew after a 60 second steep time using a Markson Colorimeter Model T-600 at a wavelength of 530 mμand using a 1 cm cell. A target value for good infusion is in the mid-sixty percentile range with transmittance decreasing as infusion improves. Having generally described the invention, the following examples are included for purposes of illustration so that the invention may be more readily understood and are in no way intended to limit the scope of the invention unless otherwise specifically indicated. All parts are given by dry weight unless otherwise specified.

The materials resulting from all of the trials, both with and without synthetic materials, comprised an acrylic agent applied as an aqueous emulsion during processing. It is believed the acrylic agent imparts strength to the resulting web materials in a known fashion. It is also believed that other aqueous agents as disclosed by the previously incorporated U.S. Pat. No. 5,431,997 would also be compatible with the present invention.

Since the basis weight of a web material may influence its physical properties, the physical test results were normalized to a theoretical basis weight of 12.3 g/m². Normalizing was accomplished by dividing a theoretical basis weight (in the present examples 12.3 g/m²) by the actual web basis weight to obtain a ratio. The ratio (or the inverse of the ration for porosity and sand sift results) was multiplied by the physical test results to obtain the normalized physical test results. Normalizing of the physical test results had the effect of raising the porosity and sand sifting results and lowering the remaining results. The reported tensile strengths are an average of the tensile strength of the web material in the direction of machine travel and in the direction perpendicular to machine travel.

### EXAMPLE 1

One single phase and five two-phase, fibrous, non-heat seal, non-woven web materials were made on an inclined wire papermaking machine. For the two phase materials, the top phase represented approximately twenty five percent of the resulting web material with the base phase accounting for the remaining seventy five percent.

The composition of the furnishes varied as shown in Table I. The top phase furnishes for trials A3 and A5 each contained twenty percent polyethylene pulp with differing base phase compositions. The polyethylene pulp represented approximately five percent of the total web material composition for trials A3 and A5.

The web material resulting from furnish A3 exhibited porosity characteristics similar to conventional materials resulting from similar conventional furnishes A2 or A4 and sifting characteristics intermediate those materials. The dry crimped seam strength of the inventive material was about twelve percent higher than material A2 and twenty percent higher than material A4.

Web material resulting from trial A5 exhibited substantially increased dry crimp strength when compared to the other nonwoven web materials of Table I. The web material of furnish A5 also exhibited similar porosity and better sifting characteristics (with the exception of material A2) when compared to web materials resulting from the other trial compositions.

The inventive material of trial A3 exhibited lower average tensile strength than materials A2 or A4. The material of trial A5 also exhibited lower average tensile strength than the conventional non-woven web materials. The average tensile strength results for the inventive materials demonstrate the minimal activation and bonding of the synthetic materials within the non-woven web.

TABLE I

| TRIAL | A1 | A2 | A3 | A4 | A5 |
|---|---|---|---|---|---|
| TOP PHASE (%) | none | — | — | — | — |
| Wood | | 100 | 80 | 80 | 80 |
| Hemp | | — | — | 20 | — |
| Polyethylene pulp | | — | 20 | — | 20 |
| BASE PHASE (%) | | | | | |
| Wood | 70 | 70 | 70 | 70 | 50 |
| Kenaf | — | — | — | — | 25 |
| Hemp | 30 | 30 | 30 | 30 | 25 |
| WEB BASIS WT g/m² | 14.4 | 14.4 | 14.3 | 14.8 | 14.0 |
| INFUSION | | | | | |
| 1^{st} color seconds | 6.9 | 6.8 | 6.9 | 6.5 | 7.0 |
| % Transmittance | 69.4 | 68.8 | 69.5 | 68.9 | 68.8 |
| NORMALIZED | | | | | |
| PHYSICALS | | | | | |
| WEB BASIS WT g/m² | 12.3 | 12.3 | 12.3 | 12.3 | 12.3 |
| POROSITY L/min | 613 | 674 | 639 | 656 | 636 |
| AVG DRY TENSILE | 1355 | 973 | 963 | 1147 | 787 |
| G/25 mm | | | | | |
| A SAND % LOSS | 0.91 | 0.21 | 0.26 | 0.78 | 0.34 |
| DRY CRIMP g/in | 64 | 94 | 109 | 86 | 131 |
| MD TEAR g | 13 | 13 | 15 | 16.6 | 11 |
| CD TEAR g | 17 | 14.5 | 15.4 | 17 | 11.3 |

### EXAMPLE 2

Three single phase, fibrous, non-heat seal, non-woven web materials were made on an inclined wire papermaking machine. The single phase web materials differed only in the replacement of twenty percent Kenaf fiber with twenty percent polyethylene pulp (trial B2) or twenty percent polypropylene pulp (trial B3).

As can be seen from the results in Table II, the substitution of modest amounts of either synthetic pulp material for the Kenaf fiber resulted in surprisingly large increases in dry crimp strength. Trial B3, while having the greatest improvement in dry crimped seam strength, exhibited highest porosity and sifting within the B1-B3 test material group.

Both of the inventive web materials, B2 and B3, exhibited lower tensile strengths than the comparison material. The lowered tensile strengths again demonstrate the limited activation of the synthetic materials and fusion of the synthetic materials within the web.

TABLE II

| TRIAL | B1 | B2 | B3 |
|---|---|---|---|
| SINGLE PHASE (%) | | | |
| Wood | 22 | 22 | 22 |
| Kenaf | 28 | 8 | 8 |
| Abacca | 50 | 50 | 50 |
| Polyethylene pulp | — | 20 | — |
| Polypropylene pulp | — | — | 20 |
| WEB BASIS WT g/m² | 16.4 | 15.2 | 16.2 |
| INFUSION | | | |
| 1^{st} color seconds | 6.8 | 6.6 | 6.7 |
| % Transmittance | 69.4 | 68.7 | 69.6 |
| NORMALIZED | | | |
| PHYSICALS | | | |
| WEB BASIS WT g/m² | 12.3 | 12.3 | 12.3 |
| POROSITY L/min | 766 | 698 | 911 |
| AVG TENSILE g/25 mm | 1758 | 1326 | 1174 |
| “A” SAND SIFT % | 1.12 | 0.76 | 3.1 |
| DRY CRIMP g/in | 45.2 | 73.8 | 135 |
| MD TEAR g | 23 | 22.1 | 25.6 |
| CD TEAR g | 23 | 23.6 | 21.9 |
| MODIFIED DELAM 0.38 | 0 | 38.2 | 33.4 |
| sec, g/in | | | |
| MODIFIED DELAM 0.76 | 0 | 49.4 | 52.6 |
| sec, g/in | | | |
| MODIFIED DELAM 1.52 | 0 | 50.8 | 48.8 |
| sec, g/in | | | |

### EXAMPLE 3

Trial B4 created a two-phase, nonwoven web material with the top phase containing one hundred percent wood fibers. Trial B5 created a two-phase nonwoven web material similar to trial B4, with twenty percent polyethylene pulp replacing twenty percent of the wood fiber in the top phase. The polyethylene pulp represented approximately five percent of the total web material composition of trial B5. The top phase represented approximately twenty five percent of the resulting web material with the base phase accounting for the remaining seventy-five percent.

As can be seen in Table III the replacement of twenty percent wood fiber with twenty percent polyethylene pulp in the top phase significantly increased the dry crimp strength (approximately 28 percent) as well as improved the sifting characteristics and lowered the porosity of the resulting web material. The average tensile strength for the material of trial B5 was similar to that of comparison material B4 when machine repeatability is considered.

TABLE III

| TRIAL | B4 | B5 |
|---|---|---|
| TOP PHASE (%) | | |
| Wood | 100 | 80 |
| Polyethylene pulp | — | 20 |
| BASE PHASE (%) | | |
| Kenaf | 35 | 35 |
| Abacca | 65 | 65 |
| WEB BASIS WT g/m² | 13.4 | 14.89 |
| INFUSION | | |
| 1^{st} COLOR SECONDS | 6.5 | 6.5 |
| % TRANSMITTANCE | 69.3 | 67.8 |
| NORMALIZED | | |
| PHYSICALS | | |
| WEB BASIS WT g/m² | 12.3 | 12.3 |
| POROSITY L/min | 907 | 796 |
| AVG DRY TENSILE | 1354 | 1342 |
| g/25 mm | | |
| “A” SAND SIFT % | 0.54 | 0.27 |
| DRY CRIMP g/in | 52.5 | 73.6 |
| MD TEAR g | 15.9 | 14.25 |
| CD TEAR g | 15.9 | 16.1 |
| MODIFIED DELAM 0.38 | 0 | 19.3 |
| sec, g/in | | |
| MODIFIED DELAM 0.76 | 0 | 31.8 |
| sec, g/in | | |
| MODIFIED DELAM 1.52 | 0 | 21.7 |
| sec. g/in | | |

Materials from trials B1-B5 were also tested for heat seal seam strength. Since samples B1 and B4 contained no fusible fibers, when these samples were placed under either standard or the below described “aggressive” heat seal test conditions, there was, as expected, no measurable bond formed. Samples B2, B3 and B5, containing up to twenty percent synthetic fibrous material, also showed insignificant heat seal seam strengths under normal test conditions (results not shown in Tables II or III). In fact, the inventive web materials displayed no evidence of “tackiness” at all under the normal test conditions.

In an effort to “force” heat sealing of the inventive web materials, samples B1-B5 were subjected to an aggressively modified heat seal seam strength test. The test temperature was unchanged from the standard test, however the cylinder pressure was increased to 80 psi, the maximum possible or the test equipment. Attempts were made to create a heat seal seam at the normal dwell time of 0.38 seconds, twice the normal dwell time (0.76 s) and four times the normal dwell time (1.52 s). Even under these aggressive test conditions, the samples containing fusible fibers exhibited heat seal seam strengths (see MODIFIED DELAM rows in TABLES II and III) of only 24 to 70 g/in. These bond strengths are well below the 300 g/in achieved by a typical heat sealable web material under normal test conditions and substantially below the 150 g/in needed to be considered an acceptable bond. Thus, while some minimal heat sealing may be achieved with the inventive materials under unusually aggressive conditions, these materials are not suitable replacements for heat seal type web materials or for use on heat sealing equipment.

Even if the synthetic materials have been substantially activated, the web material would not be expected to exhibit adequate heat seal seam bonding under normal test conditions. The lack of not only heat seal seam strength, but also any evidence of tackiness under normal test conditions, again demonstrates the lack of activation and minimal fusion of the synthetic materials within the inventive web material.

### EXAMPLE 4

Three two phase, fibrous, non-heat seal, non-woven web materials were produced. The basis weight for the materials of this example was higher than the other examples. The top phase of the materials of Example 4 represented about one third of the resulting web material while the base phase accounted for the remaining two thirds.

The two phase web materials differed from a comparison web material (trial C1) only in the replacement of Kenaf fiber in the base phase with three percent polypropylene fiber (trial C2) or four and one half percent polypropylene fiber (trial C3). The synthetic fiber materials represent approximately two percent (trial D2) and three percent (trial C3) of the respective web material compositions. The polypropylene fibers used had an average fiber length of 5 mm and an average denier of about 2.2.

The dry crimp strengths shown in Table IV are an average of twenty-one tests. As can be seen, the substitution of minimal amounts of synthetic fiber material resulted in surprisingly large increases in dry crimp strength, greater than 30 percent for the material resulting from trial C2 and 70 percent for material resulting from trial C3. The surprising improvements in dry crimp strength were achieved with relatively little impact on the remaining properties of the inventive web materials as compared to the comparison material.

TABLE IV

| TRIAL | C1 | C2 | C3 |
|---|---|---|---|
| TOP PHASE (%) | | | |
| wood | 100 | 100 | 100 |
| BASE PHASE (%) | | | |
| Kenaf | 35 | 32 | 30.5 |
| Abaca | 65 | 65 | 65 |
| Polypropylene fiber | — | 3 | 4.5 |
| WEB BASIS WT g/m² | 16.9 | 15.9 | 16.0 |
| INFUSION | | | |
| 1^{st} COLOR SECONDS | 7.1 | 7.2 | 6.9 |
| % TRANSMITTANCE | 68.8 | 67.5 | 68.2 |
| NORMALIZED | | | |
| PHYSICALS | | | |
| BASIS WT g/m² | 12.3 | 12.3 | 12.3 |
| POROSITY L/min | 993 | 875 | 1070 |
| AVG DRY TENSILE | 1620 | 1610 | 1605 |
| g/25 mm | | | |
| “A” SAND SIFT % | 3.0 | 2.1 | 2.0 |
| AVG. DRY CRIMP G/IN | 73.5 | 102 | 134 |
| MD TEAR g | 19.1 | 16.2 | 14.8 |
| CD TEAR g | 17.8 | 13.9 | 14.8 |

### EXAMPLE 5

Three two phase, fibrous, non-heat seal non-woven web materials were produced. The top phase represented approximately twenty five percent of the resulting web material with the base phase accounting for the remaining seventy five percent.

The two phase web materials differed from a comparison web material (trial D1) only in the replacement of wood fiber in the top phase with forty percent polypropylene pulp (trial D2) or forty percent polyester fibers (trial D3). The synthetic materials represented approximately ten percent of the total web material compositions of trials D2 and D3. The polyester fibers used had an average fiber length of 5 mm and an average denier of about 1.5 to 2.0.

As can be seen from the results in Table V, the substitution in trial D2 of forty percent polypropylene pulp material for wood fiber in the top phase resulted in a large increase in dry crimp strength. The substitution in trial D3 of forty percent polyester fiber for wood fiber increased the dry crimp strength a greater amount than the similar polypropylene pulp substitution of trial D2.

Porosity of the material resulting from trial D3 was greater than comparison material (trial D1) but was less than that of the material resulting from trial D2. The sifting of both trial materials D2 and D3 was greater than the comparison material, although the polyester fiber modified material was somewhat lower than the polypropylene pulp modified material.

Notably, even with large amounts of synthetic materials the average tensile strengths for trial materials D2 and D3 were lower than the comparison material.

TABLE V

| TRIAL | D1 | D2 | D3 |
|---|---|---|---|
| TOP PHASE (%) | | | |
| wood | 100 | 60 | 60 |
| Polypropylene pulp | — | 40 | — |
| Polyester fiber | — | — | 40 |
| BASE PHASE (%) | | | |
| Kenaf | 35 | 35 | 35 |
| Abaca | 65 | 65 | 65 |
| WEB BASIS WT g/m² | 14.9 | 14.7 | 15.3 |
| INFUSION | | | |
| 1^{st} COLOR SECONDS | 6.7 | 6.9 | 6.7 |
| % TRANSMITTANCE | 65.4 | 67.3 | 67.8 |
| NORMALIZED | | | |
| PHYSICALS | | | |
| BASIS WT g/m² | 12.3 | 12.3 | 12.3 |
| POROSITY L/min | 876 | 1345 | 993 |
| AVG DRY TENSILE | 1925 | 1295 | 1607 |
| g/25 mm | | | |
| “A” SAND SIFT % | 0.36 | 2.98 | 1 .24 |
| DRY CRIMP g/in | 155.0 | 197.0 | 223.0 |
| MD TEAR g | 17.3 | 20 | 23.3 |
| CD TEAR g | 18.1 | 17.5 | 20.2 |

The results of the above Examples show that the crimped mechanical seam strength for a non-woven, natural fiber web material may be increased by the addition synthetic materials. The synthetic materials may be synthetic fibers, synthetic pulps or mixtures thereof and include both thermoplastic and thermoset materials. Further, the effect is achieved over a wide range synthetic material concentrations, with minimal amounts of added synthetic material creating a surprising increase in crimped mechanical seam strength.

As will be apparent to persons skilled in the art, various modifications, adaptations and variations of the foregoing specific disclosure can be made without departing from the teaching of the present invention.

What is claimed:

1. A fibrous non-woven non-heat seal porous web material comprising 0.5 to 25 percent by weight of synthetic material with natural fibers comprising the remainder of said web material.

2. The web material of claim 1 comprising 1 to 10 percent by weight synthetic material.

3. The web material of claim 2, wherein the natural fibers are selected from the group consisting of jute, kraft, abaca, hemp, kenaf, wood and mixtures thereof.

4. The web material of claim 1 having a basis weight of 9 to 19 g/m².

5. The web material of claim 1, wherein the synthetic material is not fully thermally activated.

6. The web material of claim 1, wherein the synthetic material consists of a synthetic pulp having a micro-fibrillar structure.

7. The web material of claim 6, wherein the synthetic pulp consists of a polyolefin material.

8. The web material of claim 1, wherein the synthetic material is selected from the group consisting of polyethylene, polypropylene, polyester and mixtures thereof.

9. The web material of claim 1 comprising a first phase and a second phase juxtaposed to said first phase.

10. The web material of claim 9 wherein the synthetic material is in either the first phase or the second phase.

11. The web material of claim 1, wherein the natural fibers consist of long natural fibers.

12. The web material of claim 1 having a dry crimp strength at least twenty percent greater than a fibrous non-woven non-heat seal porous web material of the same composition without the synthetic material.

13. The web material of claim 1 having a synthetic material amount insufficient to form a heat seal bond.

14. The web material of claim 1 having a first color within the range of 6 to 8 seconds and a %transmittance within the range of 50 to 75.

15. An infusion package comprising a fibrous non-woven non-heat seal porous web material comprising 0.5 to 25 percent by weight of non-activated synthetic material with natural fibers comprising the remainder of said web material, said web material being mechanically folded to enclose a beverage precursor material therein.

16. A process of making a fibrous non-woven non-heat seal porous web material of enhanced dry crimp strength comprising:
forming a slurry of natural fibers;
adding synthetic materials in an amount insufficient to form a heat seal bond to said slurry to form a furnish;
wet laying said furnish to form a web; and
drying said web to form said web material.

17. The process of claim 16, wherein said web material comprises 0.5 to 25 percent synthetic materials.

18. The process of claim 16, wherein said web material has a basis weight of 11 to 17 g/m2 and comprises 1 to 10 percent synthetic materials.

19. The process of claim 16, wherein said fibrous non-woven non-heat seal porous web material comprises a first phase juxtaposed to a second phase and further comprising the step of wet laying an additional furnish to form one of said first or second phases.

20. The process of claim 16, wherein said web material has a first color within the range of 6 to 8 seconds and a %transmittance within the range of 50 to 75.
